(19) United States
(12) Patent Application Publication
(10) Pub. No.: US 2009/0134973 A1
(43) Pub. Date: May 28, 2009

(54) Plug & Play and Security Via RFID For Handheld Devices

(76) Inventors: Robert Sandler, Melville, NY (US); David Bellows, Wantagh, NY (US); Shane MacGregor, Forest Hills, NY (US)

Correspondence Address: Fay Kaplun & Marcin, LLP/ Motorola, 150 Broadway Suite 702, New York, NY, 10038, US

(21) Appl. No.: 11/944,894

(22) Filed: Nov. 26, 2007

(51) Int. Cl. G08B 13/14

(52) U.S. Cl. 340/10.1

(57) ABSTRACT

A system comprises an accessory and a mobile device. The accessory comprises an RFID tag including accessory information. The mobile device comprises an RFID reader reading the RFID tag. The mobile device is configured to operate with the accessory based on the accessory information. A method comprises receiving, by an RFID reader of a mobile device, an RFID signal from an RFID tag associated with an accessory of the mobile device; determining accessory information from the RFID signal; and configuring the mobile device to operate with the accessory based on the accessory information.

### FIELD OF THE INVENTION

The present invention relates generally to systems and methods for authenticating, securing and automatically configuring mobile devices and mobile device accessories using Radio Frequency Identification (hereinafter “RFID”).

### BACKGROUND

Modern mobile devices are typically capable of supplementing their capabilities by interfacing with various types of accessories. Connection of an accessory to a mobile device typically requires that a user set up the device and/or the accessory to properly communicate with one another.

Manual setup of mobile devices and accessories entails significant time on the part of the user, who must typically navigate through a series of menus and settings in order to properly configure accessory software information. Further, even if properly performed, this configuration process does not ensure that an accessory is a genuine component that may function properly, as opposed to a third-party or counterfeit accessory which may fail or even damage the mobile device.

Additionally, because of their portable nature, mobile devices are vulnerable to theft. Traditional theft deterrents that are effective for desktop computers (e.g., security chains) are ineffective in preventing theft of mobile devices.

### SUMMARY OF THE INVENTION

The present invention relates to a system comprising an accessory and a mobile device. The accessory comprises an RFID tag including accessory information. The mobile device comprises an RFID reader reading the RFID tag. The mobile device is configured to operate with the accessory based on the accessory information.

### BRIEF DESCRIPTION OF THE DRAWINGS

FIG. 1 shows a exemplary system according to the present invention.

FIG. 2 shows a first exemplary method according to the present invention, by which the exemplary system of FIG. 1 may operate.

FIG. 3 shows a second exemplary method according to the present invention, by which the exemplary system of FIG. 1 may operate.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method for use by mobile devices. Using the exemplary embodiments, a mobile device may achieve “Plug and Play” connectivity with attached accessories by using RFID communication to identify, authenticate, and configure such accessories and the mobile device to operate with the accessories.

A “mobile device,” as used in this disclosure, may refer to any type of mobile computing device that may be capable of interfacing with accessories. For example, the mobile device may be a handheld computer, a notebook computer, a personal digital assistant (“PDA”), a scanner, a mobile telephone, a data acquisition device, a camera, a pager, etc. Similarly, an “accessory,” as used in this disclosure, may refer to any peripheral device that a user may wish to connect to a mobile device. An accessory may be, for example, a cradle, an adapter, a power supply, a cable, a data capture mechanism, a portable printer, an input device, an output device, etc.

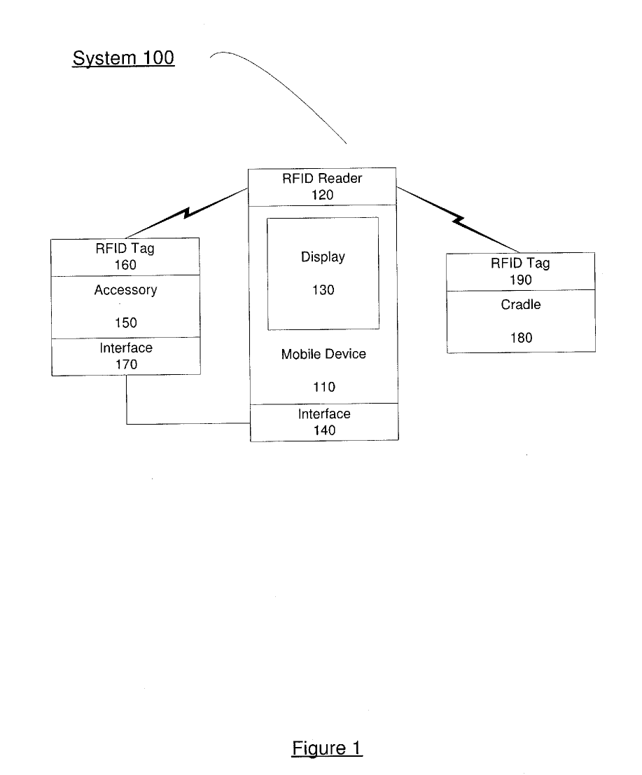

FIG. 1 shows a first exemplary embodiment of a system 100 according to the present invention. The system 100 may include a mobile device 110. The mobile device 110 may be, for example, a device of the types described above. The mobile device 110 may include an RFID reader 120, which may be capable of conducting RFID communications with other devices. The mobile device 110 may also include a display 130 (e.g., an LCD, etc.) The mobile device 110 may also include an accessory interface 140. The accessory interface 140 may be any type of communications interface, wired or wireless, which may enable the mobile device 110 to communicate with other devices (e.g., a USB port, a serial port, a parallel port, a FireWire port, an 802.11x wireless interface, a Bluetooth wireless interface, etc.). Those skilled in the art will understand that the mobile device 110 may have numerous other components.

The system 100 may also include an accessory 150. The accessory 150 may be, for example, of the types described above, and may include an RFID tag 160. The RFID tag 160 may be of any of the various types that are known in the art (e.g., passive, semi-passive, active, etc.), and may store information related to the accessory 150. The stored information may include, for example, the type of the accessory 150, authentication information regarding the manufacturer of the accessory 150, default configuration information for the accessory 150, information regarding the capabilities of the accessory 150, etc.

The system 100 may also include a cradle 180. The cradle 180 may be, for example, a charging cradle, a data interface cradle, etc. The cradle 180 may also include an RFID tag 190, which may, as for the RFID tag 160, be of any of the various types known in the art. The RFID tag 190 may also store information related to the cradle 180. The stored information may include any of the information discussed above with regards to the RFID tag 160, and additionally may include information about various mobile devices 110 that are authorized to use the cradle 180. In another exemplary embodiment of the present invention, a cradle may include an RFID reader, while a mobile device may include an RFID tag to be read for authentication purposes.

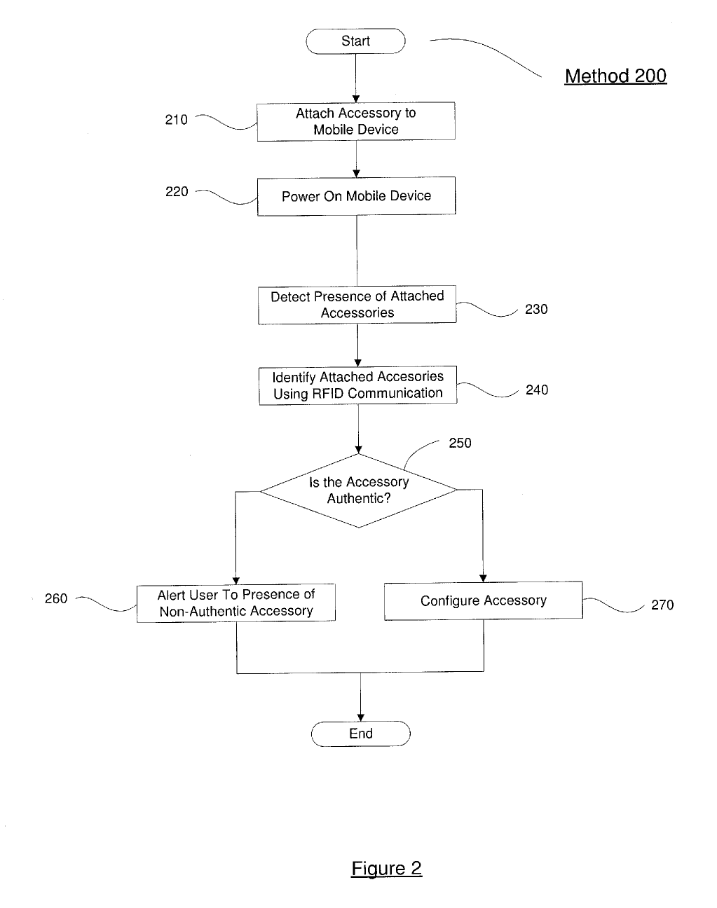

FIG. 2 shows an exemplary method 200 by which the present invention may operate. The method 200 will be described with reference to the elements of the exemplary system 100. In step 210, an accessory 150 is connected to a powered-down mobile device 110. This may typically be accomplished through the interface 140 of the mobile device 110 and the interface 170 of the accessory 150. For example, if the interfaces 140 and 170 are serial interfaces, this may be accomplished by inserting the serial interface 170 of the accessory 150 into the serial interface 140 of the mobile device 110. Some accessories may be snap-on type accessories (e.g., the accessory semi-permanently connects to a housing of the mobile device). In other examples, the accessory may have an electrical or data connection to the mobile device via a cable but is not physically attached to the mobile device.

In step 220, a user powers on the mobile device. It should be noted that in other exemplary embodiments of the present invention, an accessory 150 may be connected to a mobile device 110 that is already powered on (i.e., the order of steps 210 and 220 may be transposed).

In step 230, the mobile device 110 detects the presence of the accessory 150. This detection may take place automatically when the mobile device 110 is powered on, or when (in alternate exemplary embodiments) a connection is detected at the interface 140 of a previously powered-on mobile device 110. Alternately, the detection step 230 may occur upon the selection of a command to detect plug and play devices, which may, for example, be a selectable option in the operating system software that operates the mobile device 110. In step 240, the mobile device 110 uses the RFID reader 120 to identify the accessory 150. In this step, the RFID reader 120 communicates with the RFID tag 160 and reads information from the RFID tag 160. As described above, this may include information regarding the type of the accessory 150, the settings to be used by the mobile device 110 to use the accessory 150, etc.

In step 250, the mobile device 110 authenticates the accessory 150 using information read from the RFID tag 160 using the RFID reader 120. This authentication step may ensure that the accessory 150 was manufactured by the same supplier as the mobile device 110. In other exemplary embodiments, it may ensure that the accessory 150 was manufactured by a supplier from a list of trusted suppliers, or it may verify the authenticity of the accessory in some other manner. Authentication may be accomplished by verifying a password-protected Electronic Product Code (“EPC”) identification embedded in the RFID tag 160. Alternately, authentication may be accomplished by verifying an identifier stored on the RFID tag 160 that is either a variant of an EPC or another type of identifier suitable for accomplishing the same result. In other embodiments of the present invention, authentication information may be stored remotely, such as on a database accessible by the device 110 via the Internet; such a database may also be capable of storing other information, such as the service history of the accessory 150. If it is determined that the accessory 150 is not authentic, then the method proceeds to step 260, where the user of the mobile device 110 is alerted to this fact. This alert may be accomplished by displaying an error message on the display 130, by sounding an audible alarm, by vibrating, or in any other matter that may alert the user. Following step 260, the method terminates.

If, in step 250, it is determined that the accessory 150 is authentic, then the method proceeds to step 270. In step 270, the mobile device 110 is automatically configured to interface with the accessory 150. This automatic configuration process 270 takes the place of the manual configuration discussed above with reference to prior existing methods of configuring accessories. In this exemplary embodiment, the mobile device 110 is configured to operate the accessory 150 based on a known default setting. Such default settings may be stored in a memory of the mobile device 110 for a selected set of accessories. Alternately, settings may be stored in the RFID tag 160 and obtained by the mobile device 110 using the RFID reader 120. In other exemplary embodiments, a memory of the mobile device 110 may store configuration settings for previously used accessories, including settings that a user may have modified from previously obtained defaults. In such embodiments, the mobile device 110 may first determine whether prior settings are available, and load default settings as described above if no prior settings exist. Once the mobile device 110 has been configured to interface with the accessory 150, the method terminates.

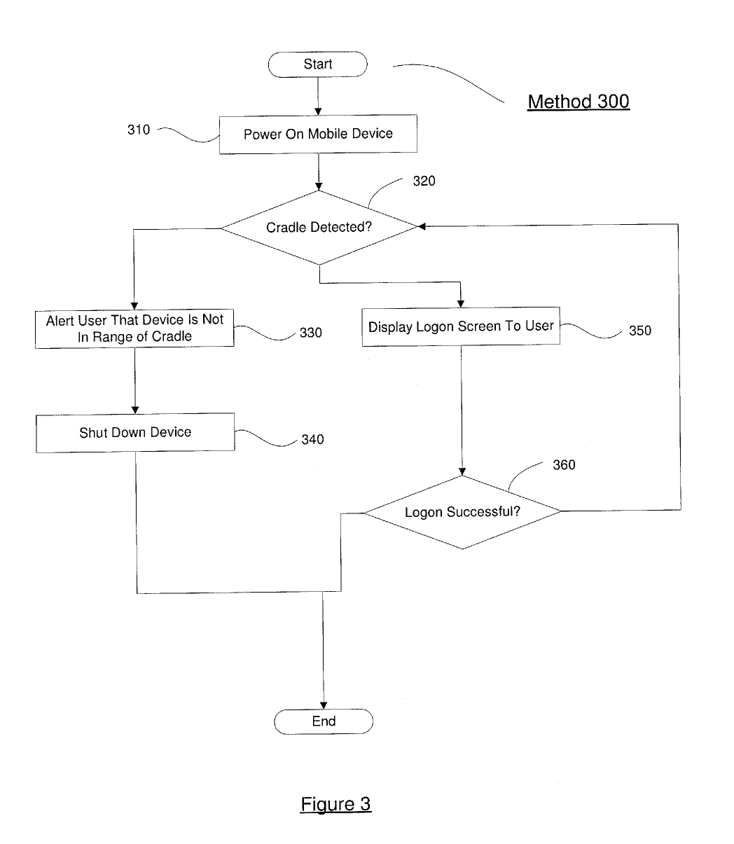

FIG. 3 shows an exemplary method 300 by which the present invention may operate; the method 300 is an example of a type of method by which the device can be configured to interface with an accessory (e.g., in this exemplary method, a cradle). The method 300 will be described with reference to the elements of the exemplary system 100. In step 310, a mobile device 110 is powered on. In step 320, the mobile device 110 detects whether a cradle 180 is present within communication range of the RFID reader 120. This detection may be accomplished by using the RFID reader 120 to scan for and communicate with the RFID tag 190. If no cradle 180 is found within range, the method proceeds to step 330, wherein a user of the mobile device 110 is alerted that the device is not within range of a cradle 180. As above, this alert may occur by displaying an error message on the display 130, by sounding an audible alert, by vibrating, etc. Subsequently, in step 340, the mobile device 110 automatically shuts itself down. In another exemplary embodiment of the present invention, the mobile device 110 may shut down without providing an alert to the user. Following step 340, the method terminates.

If the mobile device 110 detects a cradle 180 within communication range in step 310, then the method proceeds to step 350, wherein the mobile device 110 displays a logon screen to the user. In step 360, the mobile device 110 determines whether the user has entered valid logon information. If logon has been properly accomplished, the method terminates and normal operation of the mobile device 110 can follow. If logon information is not proper, the method returns to step 320.

In one exemplary embodiment, the software that operates the mobile device 110 may be written so that the identity of a cradle 180 corresponding to the mobile device 110 is written to a specific flash memory location. Thus, even when a battery is removed from the mobile device 110 and the device reboots itself, resulting in loss of the contents of PAM, the first application to be run will immediately begin searching for the cradle 180 once the mobile device 110 is powered back on.

In another exemplary embodiment of the present invention, the powered-on mobile device 110 and the RFID reader 120 may be configured to continuously monitor for the proximity of the cradle 180 and its corresponding RFID tag 190. In such an embodiment, the mobile device 110 may be configured to alert a user (e.g., by displaying an error message, generating an audible error tone, vibrating, etc.) if the mobile device 110 is moved beyond a predetermined distance from the cradle 180. This may be useful if the mobile device 110 functions by communication with a local wireless network; such an alert may then warn the user that the device will cease to function properly.

In this exemplary embodiment, by only allowing a mobile device to turn on when it is in close proximity to its home cradle (e.g., as part of a daily startup procedure), the mobile device can be secured. Removing the device from the immediate area surrounding the cradle without first inputting a valid logon would render the device inoperative. This would deter theft, as a device that does not power on is a less appealing candidate for theft.

In other exemplary embodiments, by authenticating an accessory or accessories that have been attached to the mobile device, proper cooperation between the two may be ensured. The use of incompatible or counterfeit accessories may lead to malfunctions in mobile devices or even permanent damage to the affected mobile devices. Such malfunctions may also result in service calls, requiring service personnel to fix failures that have been caused by the use of incompatible or counterfeit accessories, and as a result consuming still more operational resources.

In other exemplary embodiments of the present invention, the RFID tag 160 may be used to change the default parameters of the accessory 150. This may be desirable, for example, where adjustment of the parameters may be required in a large scale rollout due to a functional limitation. In such an embodiment, after the accessory 150 has been authenticated by the device 110 as described above, the mobile device 110 can send a change configuration request command to the accessory 150. If the accessory 150 responds with acceptance, the mobile device 110, using the RFID reader 120, may then reprogram the RFID tag 160 in the accessory 150 to match the newly requested configuration.

In addition, by providing automatic plug-and-play configuration for mobile device accessories, the process of attaching accessories is greatly simplified. No user intervention is required to arrive at a functional configuration for the accessory and the device, meaning that the user's time and effort can be expended elsewhere. Additionally, for exemplary embodiments of the present invention that recall previously used settings for attached accessories, customization can be achieved without manually entering settings each time the accessory is reattached to the device.

The present invention has been described with reference to the above specific exemplary embodiments. However, those of ordinary skill in the art will recognize that the same principles may be applied to other embodiments of the present invention, and that the exemplary embodiments should therefore be read in an illustrative, rather than limiting, sense.

What is claimed is:

1. A system, comprising:
an accessory including an RFID tag having accessory information; and
a mobile device including an RFID reader reading the RFID tag, the mobile device being configured to operate with the accessory based on the accessory information.

2. The system of claim 1, wherein the mobile device further determines an authenticity of the accessory, and if the accessory is determined not to be authentic, the mobile device issues an alert.

3. The system of claim 1, wherein, the RFID reader is configured to read the RFID tag if one of the mobile device is powered on and the mobile device detects the accessory is connected to the mobile device.

4. The system of claim 1, wherein, if the mobile device does not receive the accessory information within a predetermined time, the mobile device is powered off.

5. The system of claim 4, wherein the accessory is a cradle.

6. The system of claim 1, wherein the mobile device uses a set of default settings for configuring operation with the accessory.

7. The system of claim 6, wherein the set of default settings is obtained from one of the RFID tag and a memory of the mobile device.

8. A method, comprising:
receiving, by an RFID reader of a mobile device, an RFID signal from an RFID tag associated with an accessory of the mobile device;
determining accessory information from the RFID signal; and
configuring the mobile device to operate with the accessory based on the accessory information.

9. The method of claim 8, further comprising:
determining an authenticity of the accessory as a function of the accessory information.

10. The method of claim 9, further comprising:
alerting a user of the mobile device, if the accessory is determined not to be authentic.

11. The method of claim 8, wherein the mobile device is configured using a set of default settings for configuring operation with the accessory.

12. The method of claim 11, wherein the set of default settings is obtained from one of the RFID tag and a memory of the mobile device.

13. The method of claim 8, wherein the mobile device is configured using a set of previous settings for configuring operation with the accessory.

14. The method of claim 8, further comprising:
detecting the presence of the accessory prior to receiving the RFID signal.

15. The method of claim 8, further comprising:
reprogramming the RFID tag with a set of new settings for the accessory.

16. A mobile device, comprising:
an accessory interface receiving an accessory including an RFID tag, the RFID tag including information associated with the accessory;
an RFID reader reading the information from the RFID tag; and
a processor receiving the information and configuring the mobile device to operate with the accessory.

17. The mobile device of claim 16, wherein the processor instructs the RFID reader to read the RFID tag each time the mobile device is powered on.

18. The mobile device of claim 16, wherein if the processor does not receive the information within a predetermined time, the processor powers off the mobile device.

19. The mobile device of claim 16, further comprising:
a non-volatile memory storing configuration data corresponding to the information.

20. The mobile device of claim 16, wherein the mobile device uses a set of previous settings for configuring operation with the accessory.

21. The mobile device of claim 16, further comprising:
a display displaying a logon screen to a user as a process of the configuration of the mobile device.

22. The mobile device of claim 16, wherein, when an accessory comprising an RFID tag is connected to the accessory interface, the RFID reader reads the RFID tag and determines an authenticity of the accessory.

23. The mobile device of claim 16, wherein, when an accessory without an RFID tag is connected to the accessory interface, the mobile device alerts a user of the device.

24. A mobile device, comprising:
a means for receiving an accessory including an RFID tag, the RFID tag including information associated with the accessory;
a means for reading the information from the RFID tag; and
a means for receiving the information and configuring the mobile device to operate with the accessory.
